(19) United States
(12) Patent Application Publication
(10) Pub. No.: US 2019/0310920 A1
(43) Pub. Date: Oct. 10, 2019

(54) Pre-Fetching and Staging of Restore Data on Faster Tiered Storage

(71) Applicant: International Business Machines Corporation, Armonk, NY (US)

(72) Inventors: Kurt Rybczyk, New Haven, CT (US); Christopher C. Bode, Cary, NC (US); Lisa A. Shepard, Newtown, CT (US); Matthew Lavigne, Cobleskill, NY (US)

(21) Appl. No.: 15/945,160

(22) Filed: Apr. 4, 2018

(51) Int. Cl. G06F 11/14; G06F 7/08; G06N 7/00

(52) U.S. Cl. CPC G06F 11/1464; G06F 11/1469; G06F 2201/84; G06N 7/005; G06F 7/08

(57) ABSTRACT

Pre-fetching and staging restore data is provided. A set of data corresponding to a client device is collected from each respective data source in a plurality of data sources. A score is determined for each set of data collected. A probability of receiving a request to restore backup data on the client device is predicted based on analysis of the set of data from each respective data source and the score for each set of data. It is determined whether the predicted probability of receiving a request to restore the backup data on the client device is greater than a threshold. In response to determining that the predicted probability of receiving a request to restore the backup data on the client device is greater than the threshold, the backup data of the client device is preemptively moved to a fastest data storage tier in a multi-tiered backup data storage system.

### BACKGROUND

### 1. Field

The disclosure relates generally to restoring data and more specifically to pre-fetching and staging restore data of a client device on a faster restore data staging tier of a multi-tiered data storage system for faster data recovery on the client device.

### 2. Description of the Related Art

In information technology, a backup, or the process of backing up data, refers to the copying and storing of computer data so that the backup data may be used to restore the original data in the event of a computer crash, data corruption, or data loss, for example. A backup data system contains at least one copy of all data considered worth saving. Organizing this data storage space and managing the backup process can be complicated. Currently, many different types of data storage media exist for backing up data.

Tiered storage is the assignment of different categories of data to various types of backup data storage media to reduce the cost of data storage. Storage tiers are determined by performance and cost of the media. Data is categorized by how often the data is accessed. Typically, tiered storage policies place more frequently accessed data on a faster performing, higher cost storage medium, whereas less frequently accessed data is placed on a slower performing, lower cost storage medium. Tiered storage infrastructures may range from a simple two-tiered architecture to a more complex architecture containing five or six tiers of storage media, for example.

Automated tiered storage is the automated promotion and demotion of data across different tiers (i.e., types) of storage media or devices. Automated tiered storage includes rules and policies that dictate if and when data can be moved between the different tiers.

### SUMMARY

According to one illustrative embodiment, a computer-implemented method for pre-fetching and staging restore data is provided. A computer collects a set of data corresponding to a client device from each respective data source in a plurality of data sources. The computer determines a score for each set of data collected from each respective data source. The computer predicts a probability of receiving a request to restore backup data on the client device based on analysis of the set of data collected from each respective data source and the score determined for each set of data collected from each respective data source. The computer determines whether the predicted probability of receiving a request to restore the backup data on the client device is greater than or equal to a probability threshold level. In response to the computer determining that the predicted probability of receiving a request to restore the backup data on the client device is greater than or equal to the probability threshold level, the computer preemptively moves the backup data of the client device to a fastest data storage tier in a multi-tiered backup data storage system. According to other illustrative embodiments, a computer system and computer program product for pre-fetching and staging restore data are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a flowchart illustrating a process for predicting a probability of receiving a request to restore backup data on a client device in accordance with an illustrative embodiment; and

FIGS. 4A-4B are a flowchart illustrating a process for loading backup data of a client device on a faster restore data staging tier of a multi-tiered backup data storage system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

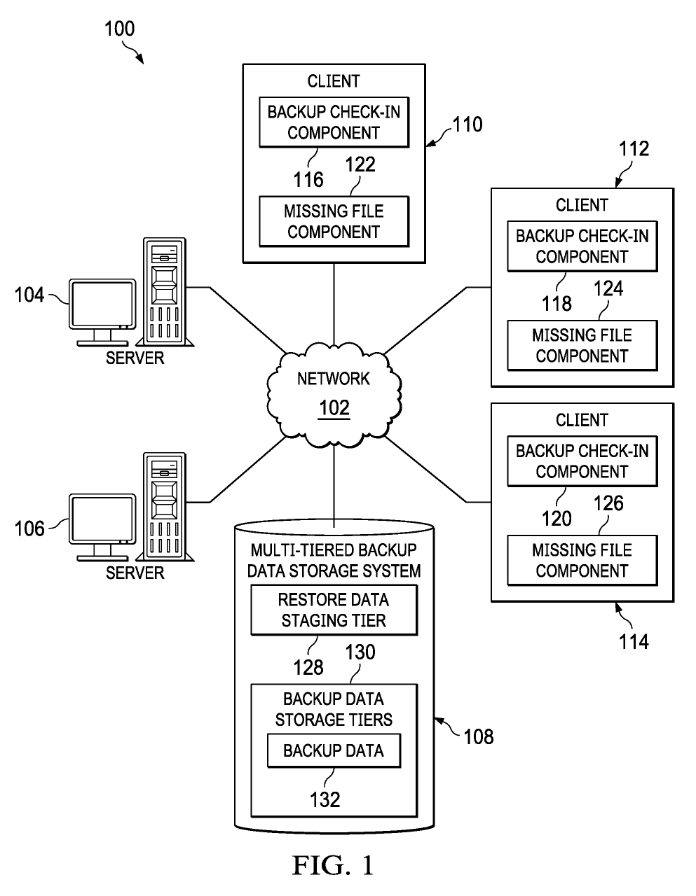

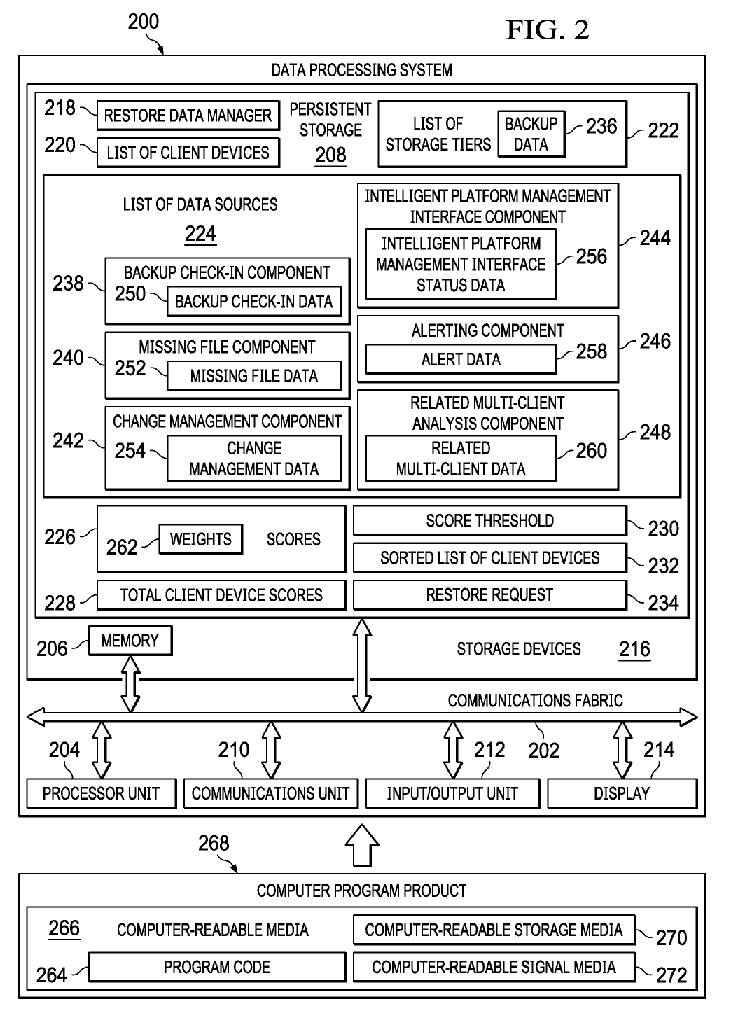

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with multi-tiered backup data storage system 108. Server 104 and server 106 may be, for example, server computers with high-speed connections to network 102. In addition, server 104 and server 106 may provide data restoration services to registered clients. In addition, server 104 and server 106 may each represent a multitude of servers. Further, server 104 and server 106 may reside in a cloud environment that provides data restoration services.

Client 110, client 112, and client 114 also connect to network 102. Clients 110, 112, and 114 are registered clients of server 104 and server 106. Clients 110, 112, and 114 may each represent, for example, a network computer, a rack of network computers, or a cluster of network computers in a data center that process data and require backing up of that data. In other words, clients 110, 112, and 114 may each represent any number of network computers. However, it should be noted that clients 110, 112, and 114 are meant as examples only. In other words, clients 110, 112, and 114 may include other types of data processing systems, such as, for example, desktop or personal computers, laptop computers, handheld computers, and the like, with wire or wireless communication links to network 102. Furthermore, server 104 and server 106 may provide information, such as software applications and programs to clients 110, 112, and 114. A user, such as a system administrator, corresponding to client 110, client 112, or client 114 may request the data restoration services provided by server 104 and/or server 106 to restore data on a client.

In this example, client 110, client 112, and client 114 include backup check-in component 116, backup check-in component 118, and backup check-in component 120, respectively. Backup check-in components 116, 118, and 120, which may be included in backup software stacks on respective clients, periodically check-in with server 104 and server 106. Missed check-ins may indicate that a client is down. In addition, client 110, client 112, and client 114 also include missing file component 122, missing file component 124, and missing file component 126, respectively. Missing file components 122, 124, and 126, which also may be included in the backup software stacks on respective clients, periodically report to server 104 and server 106 which files may be missing on respective clients.

Multi-tiered backup data storage system 108 represents a plurality of different types of backup data storage devices that store backup data for registered clients, such as clients 110, 112, and 114. Each different type of storage device represents a different data storage tier in multi-tiered backup data storage system 108. The plurality of different types of storage devices may include, for example, solid-state storage, flash storage, storage class memory, hard disk storage, recordable compact disk storage, tape storage, and the like. Further, it should be noted that multi-tiered backup data storage system 108 may include one or more of each different type of backup storage device. In addition, the plurality of different types of backup data storage devices are capable of storing any type of backup data in a structured format or an unstructured format.

In this example, multi-tiered backup data storage system 108 includes restore data staging tier 128 and backup data storage tiers 130. Restore data staging tier 128 represents a faster storage medium, such as, for example, a solid-state drive, a flash storage, or a storage class memory, as compared to slower storage media, such as, for example, a hard disk drive, a recordable compact disk, or a magnetic tape, of backup data storage tiers 130. Backup data storage tiers 130 represent a set of one or more different storage devices that store backup data 132. Backup data 132 represent backup data for clients 110, 112, and 114.

Server 104 or server 106 utilizes restore data staging tier 128 to stage or store backup data corresponding to a particular client, such as client 110, that was pre-fetched from backup data 132 for faster restoration of data on that particular client in response to server 104 or server 106 determining or predicting that a restore data request is likely to be received from a user of that particular client. As a result, server 104 or server 106 is able to perform a faster data restore on that particular client when the restore data request is received. Thus, increasing productivity and performance of that particular client by decreasing client downtime.

It should be noted that network data processing system 100 is only intended as an example and may include any number of additional server devices, client devices, and other devices not shown. In addition, program code located in network data processing system 100 may be stored on a computer readable storage medium and downloaded to a computer or data processing system for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), or any combination thereof. FIG. 1 is not intended as an architectural limitation for different illustrative embodiments.

With reference now to FIG. 2, a diagram of a data processing system is depicted in accordance with an illustrative embodiment. Data processing system 200 is an example of a data restore server computer, such as server 104 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a solid-state drive, a hard disk drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores restore data manager 218. Restore data manager 218 controls the process of pre-fetching and staging restore data of a client device on a faster restore data staging tier of a multi-tiered data storage system for faster data recovery on the client device. It should be noted that even though restore data manager 218 is illustrated as residing in persistent storage 208, in an alternative illustrative embodiment restore data manager 218 may be a separate component of data processing system 200. For example, restore data manager 218 may be a hardware component coupled to communication fabric 202 or a combination of hardware and software components. In another alternative illustrative embodiment, a first set of components of restore data manager 218 may be located in data processing system 200 and a second set of components of restore data manager 218 may be located in client devices.

In this example, persistent storage 208 also stores list of client devices 220, list of storage tiers 222, list of data sources 224, scores 226, total client device scores 228, score threshold 230, sorted list of client devices 232, and restore request 234. List of client devices 220 represents a listing of all registered clients of data processing system 200. Restore data manager 218 utilizes list of client devices 220 to identify and collect information regarding each respective client device included in the list.

List of storage tiers 222 represents a listing of all storage tiers, such as, for example, restore data staging tier 128 and backup data storage tiers 130, of a multi-tiered backup data storage system, which restore data manager 218 manages and controls. Restore data manager 218 utilizes list of storage tiers 222 to identify each different storage tier for promoting and demoting backup data 236 within the different tiers. Backup data 236 may be, for example, backup data 132 in FIG. 1.

List of data sources 224 represents a listing of different data sources for gathering information regarding each respective client device in list of client devices 220. In this example, list of data sources 224 includes backup check-in component 238, missing file component 240, change management component 242, intelligent platform management interface component 244, alerting component 246, and related multi-client analysis component 248. However, it should be noted that list of data sources 224 is only intended as an example. In other words, alternative illustrative embodiments may include more or fewer data sources than shown in list of data sources 224.

Backup check-in component 238 and missing file component 240 may be, for example, components of backup software stacks on client devices included in list of client devices 220. For example, backup check-in component 238 and missing file component 240 may be backup check-in component 116 and missing file component 122 on client 110 in FIG. 1. Backup check-in component 238 periodically checks in with restore data manager 218 by sending backup check-in data 250. Missed check-ins may indicate that a particular client device is down. Restore data manager 218 may initially increase a check-in score for a client device as a number of missed check-ins increases for that client device. However, restore data manager 218 may eventually decrease the check-in score gradually to avoid excessively scoring decommissioned client devices. Missing file component 240 periodically reports missing files to restore data manager 218 by sending missing file data 252. Restore data manager 218 may increase a file missing score for a client device as a number of missing files increases for that client device.

Change management component 242, intelligent platform management interface component 244, alerting component 246, and related multi-client analysis component 248 reside on data processing system 200. Change management component 242 monitors and tracks hardware and software changes on client devices included in list of client devices 220 by analyzing change management data 254. For example, knowing when scheduled downtime will occur, along with the degree of risk involved in a change, may allow restore data manager 218 to determine or predict the probability or likelihood of receiving a data restore request corresponding to a client device.

Intelligent platform management interface component 244 is a set of computer interface specifications that provides out-of-band management and monitoring of client device operation. For example, intelligent platform management interface component 244 provides a way to monitor a client device that may be powered off or otherwise unresponsive by using a dedicated network connection to the client device. Restore data manager 218 is able to determine a status of a client device based on intelligent platform management interface status data 256, which is provided by intelligent platform management interface component 244. Restore data manager 218 may increase a status score for a client device as periods of unavailability increase for that client device.

Alerting component 246 generates alert data 258, such as alert messages, when client devices experience significant events or fail to send periodic heartbeats. Restore data manager 218 may increase an alert score for a client device as a number of alerts increase for that client device. Related multi-client analysis component 248 generates related multi-client data 260 regarding applications having dependency relationships across a plurality of client devices. For example, a restore data request corresponding to one client device may indicate an increased likelihood of data restores on other client devices that are included in that application dependency relationship.

Restore data manager 218 generates scores 226 for each respective client device included in list of client devices 220 based on all of the collected information from each of the data sources included in list of data sources 224 regarding each respective client device. The collected information includes backup check-in data 250, missing file data 252, change management data 254, intelligent platform management interface status data 256, alert data 258, and related multi-client data 260. Further, restore data manager 218 adjusts each score in scores 226 for each particular client device using a different weight in weights 262. In other words, weights 262 represent a set of different weights for each particular client device. Weights 262 are a plurality of different factors that restore data manager 218 may apply to each particular score in scores 226 to weight each particular score differently. The factor may be positive, which will increase a weight or influence of a particular score, or may be negative, which will decrease a weight or influence of a particular score.

Restore data manager 218 generates total client device scores 228 based on scores 226, as adjusted by weights 262, for each respective client device. If a total score corresponding to a particular client device is greater than or equal to score threshold 230, then restore data manager 218 determines or predicts that a data restore request, such as restore request 234, is likely to be received for that particular client device. Further, restore data manager 218 sorts list of client devices 220 based on total client device scores 228 to form sorted list of client devices 232.

Restore data manager 218 arranges sorted list of client devices 232 in descending order so that a highest-scoring client device is listed first, a second highest-scoring client device is listed second, and so on. Restore data manager 218 utilizes sorted list of client devices 232 to determine which client device or devices will more than likely require a data restore operation and, therefore, will proactively move backup data corresponding to that client device or devices to a restore data staging tier included in the list of storage tiers 222. Upon receiving restore request 234, restore data manager 218 performs a data restore for that client device or devices using the pre-fetched data corresponding to that client device or devices stored in the restore data staging tier.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (WiFi), Bluetooth® technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keyboard, keypad, mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 264 is located in a functional form on computer readable media 266 that is selectively removable and may be loaded onto or transferred to data processing system 200 for running by processor unit 204. Program code 264 and computer readable media 266 form computer program product 268. In one example, computer readable media 266 may be computer readable storage media 270 or computer readable signal media 272. Computer readable storage media 270 may include, for example, an optical or magnetic disc that is inserted or placed into a drive or other device that is part of persistent storage 208 for transfer onto a storage device, such as a hard drive, that is part of persistent storage 208. Computer readable storage media 270 also may take the form of a persistent storage, such as a hard drive, a thumb drive, or a flash memory that is connected to data processing system 200. In some instances, computer readable storage media 270 may not be removable from data processing system 200.

Alternatively, program code 264 may be transferred to data processing system 200 using computer readable signal media 272. Computer readable signal media 272 may be, for example, a propagated data signal containing program code 264. For example, computer readable signal media 272 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 264 may be downloaded over a network to persistent storage 208 from another device or data processing system through computer readable signal media 272 for use within data processing system 200. For instance, program code stored in a computer readable storage media in a data processing system may be downloaded over a network from the data processing system to data processing system 200. The data processing system providing program code 264 may be a server computer, a client computer, or some other device capable of storing and transmitting program code 264.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 270 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In many current data backup environments, multiple tiers of data storage are used for backing up data. Some of these tiers, such as object store and tape-based technologies, which are used for longer term data retentions, provide suboptimal restore performance, particularly for emerging data protection use cases such as “boot from backup”. With tape storage, for example, when a restore request is issued, the process needs to mount a tape, seek the track location on the tape, and then begin restoring the data. In most cases, the backup data requires multiple tapes. As a result, a request to restore the data will be extended by each tape mount. If all of the backup data were to reside on fast hard disk drive local to the restore server, then the restore request could be serviced much faster.

Illustrative embodiments gather data from various sources to predict when a restore is going to be required and preemptively move the backup data stored on a slower backup storage tier to a random access-based storage tier optimized for faster data restore, thus decreasing the duration of the computer outage and increasing computer performance. Illustrative embodiments analyze the information collected from the multiple data sources and correlate the information from each source to determine when restore requests are likely to occur. Illustrative embodiments periodically score each client based on known status of each client from these weighted inputs. When the score of a client exceeds a threshold, illustrative embodiments pre-fetch most recent backup data of that client and place the pre-fetched backup data on the restore data staging storage tier. Should storage space of the restore data staging storage tier be exceeded, illustrative embodiments will demote other consuming clients with lower scores to make space available in the restore data staging storage tier.

Examples of data sources may include client backup software periodic check-ins, change management system data, intelligent platform management interface status data, alerting system data, and related multi-client analysis data. For example, many backup software stacks have clients periodically check with the server for work. Missed check-ins can indicate a client is down. The check-in score will initially increase as the number of missed check-ins increases, but may drop off to avoid excessively scoring decommissioned systems. In addition, most IT organizations implement change management procedures and change tracking as part of their ticketing system. Knowing when scheduled downtime will occur, along with the degree of risk involved in the change, may indicate a likelihood of a data restore event. Further, many hardware platforms include out-of-band monitoring. For x86 platforms, intelligent platform management interface (IPMI) is the industry standard. An unavailable IPMI interface can indicate that a client server is experiencing hardware problems. As with the check-in score, initial periods of unavailability will increase the score, but may decrease over longer timescales to avoid incorrectly decommissioned systems. Furthermore, IT alerting/monitoring systems receive alert messages when systems experience significant events or fail to send periodic heartbeats. Moreover, modern IT architectures are built around multi-system applications with dependency relationships. A restore request on one system from one of these applications can indicate an increased likelihood of restore requests from other applications.

Illustrative embodiments generate a total score for each respective client based on scoring the information from each respective data source. Illustrative embodiments also weight each respective score to generate the total score. For example, total client score=check-in score*weight 1+change management score*weight 2+IPMI score*weight 3+alerting score*weight 4. Then, illustrative embodiments sort the client scores in descending order as an array. Illustrative embodiments load backup data onto the restore data staging tier corresponding to highest-scoring clients if not already present.

Illustrative embodiments automatically adjust score weights based on actual restore event data. For example, when a restore occurs on a client were backup data was not pre-fetched, illustrative embodiments examine the total score for that particular client immediately prior to the restore to determine what weighting, if any, could have resulted in prefetching the backup data. Doing this per client with a starting variable set of weights, allows illustrative embodiments to self-customize to each particular client's environment.

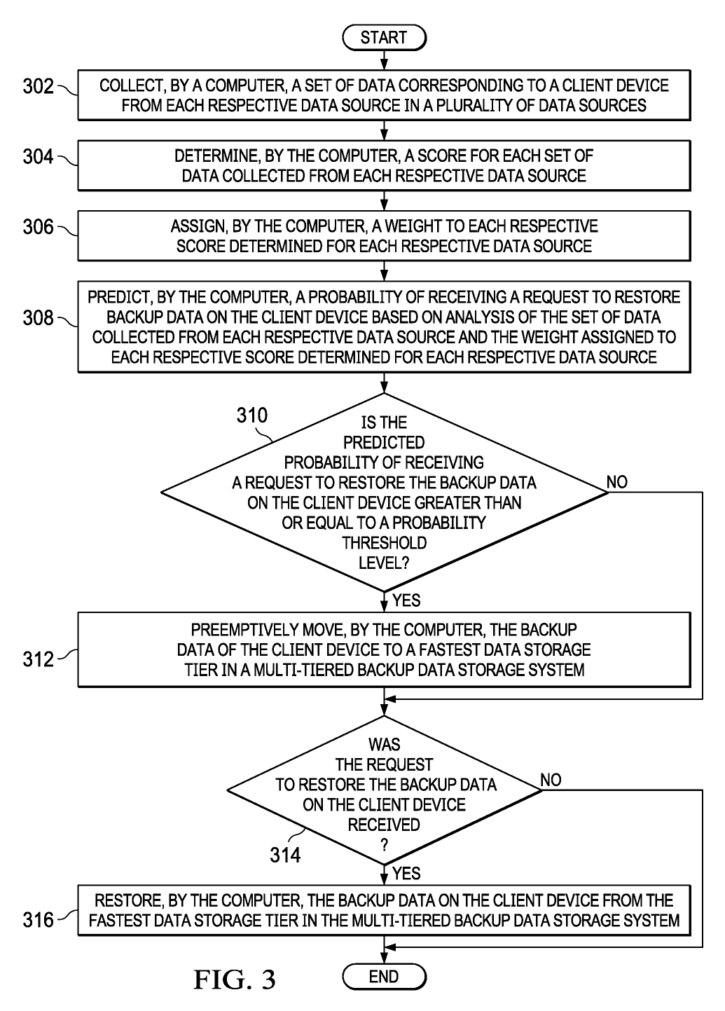

With reference now to FIG. 3, a flowchart illustrating a process for predicting a probability of receiving a request to restore backup data on a client device is shown in accordance with an illustrative embodiment. The process shown in FIG. 3 may be implemented in a computer, such as, for example, server 104 in FIG. 1 or data processing system 200 in FIG. 2.

The process begins when the computer collects a set of data corresponding to a client device from each respective data source in a plurality of data sources (step 302). The plurality of data sources may include, for example, a backup check-in component, a missing file component, a change management component, an intelligent platform management interface component, an alerting component, a related multi-client analysis component, and the like. The computer determines a score for each set of data collected from each respective data source (step 304). In addition, the computer assigns a weight to each respective score determined for each respective data source (step 306). The initial weights are set upon installation of illustrative embodiments on the computer. However, as individual data restores occur within a specific customer's environment, the computer adjusts the existing restore event weights so that if the data restores are run again with the adjusted weights, they would have been predicted.

Further, the computer predicts a probability of receiving a request to restore backup data on the client device based on analysis of the set of data collected from each respective data source and the weight assigned to each respective score determined for each respective data source (step 308). Subsequently, the computer makes a determination as to whether the predicted probability of receiving a request to restore the backup data on the client device is greater than or equal to a probability threshold level (step 310). The probability threshold level used depends on the amount of high speed storage available for housing the restore data. The lower the availability of the high speed storage is, the higher the probability must be.

If the computer determines that the predicted probability of receiving a request to restore the backup data on the client device is less than the probability threshold level, no output of step 310, then the process proceeds to step 314. If the computer determines that the predicted probability of receiving a request to restore the backup data on the client device is greater than or equal to the probability threshold level, yes output of step 310, then the computer preemptively moves the backup data of the client device to a fastest data storage tier in a multi-tiered backup data storage system (step 312).

Afterward, the computer makes a determination as to whether the request to restore the backup data on the client device was received (step 314). The request may be manually sent by a user, such as a system administrator, or automatically sent by an application, such as a restore data manager. If the computer determines that the request to restore the backup data on the client device was not received, no output of step 314, then the process terminates thereafter. If the computer determines that the request to restore the backup data on the client device was received, yes output of step 314, then the computer restores the backup data on the client device from the fastest data storage tier in the multi-tiered backup data storage system (step 316). Thereafter, the process terminates.

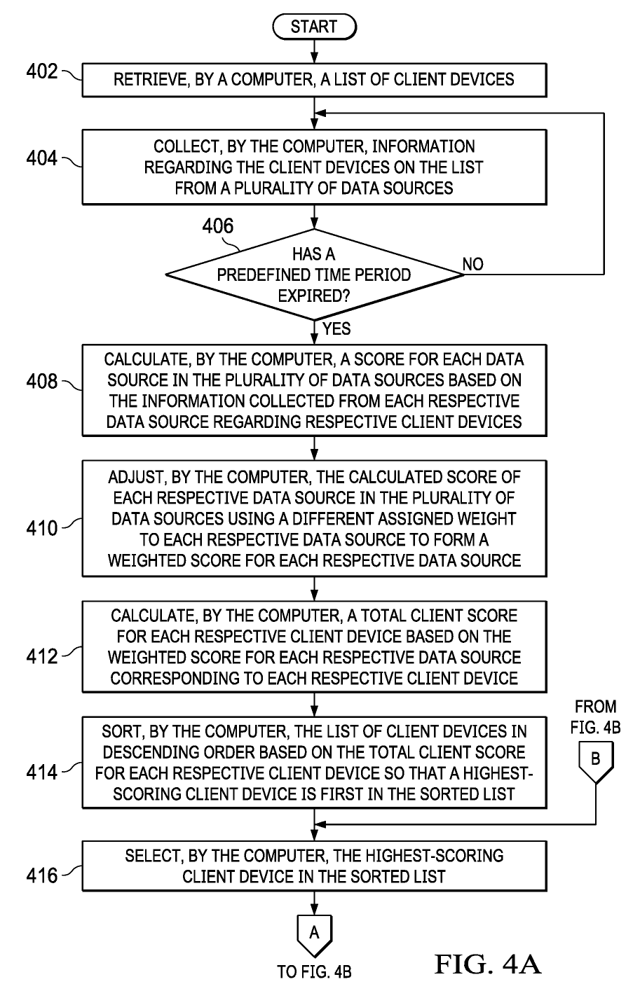

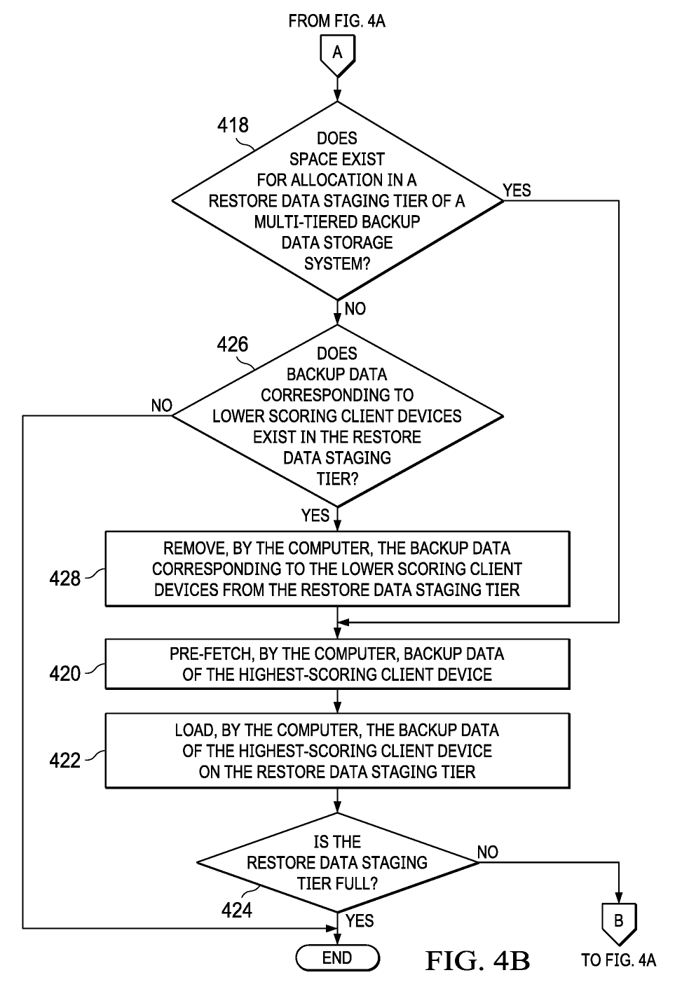

With reference now to FIGS. 4A-4B, a flowchart illustrating a process for loading backup data of a client device on a faster restore data staging tier of a multi-tiered backup data storage system is shown in accordance with an illustrative embodiment. The process shown in FIGS. 4A-4B may be implemented in a computer, such as, for example, server 104 in FIG. 1 or data processing system 200 in FIG. 2.

The process begins when the computer retrieves a list of client devices (step 402). In addition, the computer collects information regarding the client devices on the list from a plurality of data sources (step 404). The computer also makes a determination as to whether a predefined time period has expired (step 406). One advantage of using a predefined time period is that moving backup data out of slower storage types, such as, for example, object storage, isn't free of cost, so the computer does not want to continuously swap around what backup data is on the faster storage and what backup data is on the slower storage. Likewise, the computer also must consider that some data sources may update much more frequently than others. Doing a compare with some stale data and some fresh data may lead to inaccurate results. The predefined time period may be, for example, an hour, six hours, twelve hours, one day, one week, one month, or any other increment of time.

If the computer determines that the predefined time period has not expired, no output of step 406, then the process returns to step 404 where the computer continues to collect information regarding the client devices. If the computer determines that the predefined time period has expired, yes output of step 406, then the computer calculates a score for each data source in the plurality of data sources based on the information collected from each respective data source regarding respective client devices (step 408). Further, the computer adjusts the calculated score of each respective data source in the plurality of data sources using a different assigned weight to each respective data source to form a weighted score for each respective data source (step 410).

Subsequently, the computer calculates a total client score for each respective client device based on the weighted score for each respective data source corresponding to each respective client device (step 412). Furthermore, the computer sorts the list of client devices in descending order based on the total client score for each respective client device so that a highest-scoring client device is first in the sorted list (step 414). Afterward, the computer selects the highest-scoring client device in the sorted list (step 416).

The computer makes a determination as to whether space exists for allocation in a restore data staging tier of a multi-tiered backup data storage system (step 418). If the computer determines that space does exist for allocation in the restore data staging tier of the multi-tiered backup data storage system, yes output of step 418, then the computer pre-fetches backup data of the highest-scoring client device from a set of one or more backup data storage tiers (step 420). The backup data storage tiers are slower storage media than the restore data staging tier. In other words, the restore data staging tier is a fastest storage medium in the multi-tiered backup data storage system. In addition, the computer loads the backup data of the highest-scoring client device on the restore data staging tier (step 422).

Afterward, the computer makes a determination as to whether the restore data staging tier is full (step 424). If the computer determines that the restore data staging tier is full, yes output of step 424, then the process terminates thereafter. If the computer determines that the restore data staging tier is not full, no output of step 424, then the process returns to step 416 where the computer selects the next highest-scoring client device in the sorted list of client devices.

Returning again to step 418, if the computer determines that space does not exist for allocation in the restore data staging tier of the multi-tiered backup data storage system, no output of step 418, then the computer makes a determination as to whether backup data corresponding to lower scoring client devices exists in the restore data staging tier (step 426). If the computer determines that backup data corresponding to lower scoring client devices does not exist in the restore data staging tier, no output of step 426, then the process terminates thereafter. If the computer determines that backup data corresponding to lower scoring client devices does exist in the restore data staging tier, yes output of step 426, then the computer removes the backup data corresponding to the lower scoring client devices from the restore data staging tier (step 428). Thereafter, the process returns to step 420 where the computer pre-fetches that backup data.

Thus, illustrative embodiments of the present invention provide a computer-implemented method, computer system, and computer program product for pre-fetching and staging restore data of a client device on a faster restore data staging tier of a multi-tiered data storage system for faster data recovery on the client device. As a result, illustrative embodiments enable restore operations to run much faster by having the data placed on the fastest possible storage rather than having to wait for the data to come from the slower storage where backup data are traditionally held. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for pre-fetching and staging restore data, the computer-implemented method comprising:
collecting, by a computer, a set of data corresponding to a client device from each respective data source in a plurality of data sources;
determining, by the computer, a score for each set of data collected from each respective data source;
predicting, by the computer, a probability of receiving a request to restore backup data on the client device based on analysis of the set of data collected from each respective data source and the score determined for each set of data collected from each respective data source;
determining, by the computer, whether the predicted probability of receiving a request to restore the backup data on the client device is greater than or equal to a probability threshold level; and
responsive to the computer determining that the predicted probability of receiving a request to restore the backup data on the client device is greater than or equal to the probability threshold level, preemptively moving, by the computer, the backup data of the client device to a fastest data storage tier in a multi-tiered backup data storage system.

2. The computer-implemented method of claim 1 further comprising:
determining, by the computer, whether the request to restore the backup data on the client device was received; and
responsive to the computer determining that the request to restore the backup data on the client device was received, restoring, by the computer, the backup data on the client device from the fastest data storage tier in the multi-tiered backup data storage system.

3. The computer-implemented method of claim 1 further comprising:
assigning, by the computer, a weight to each respective score determined for each respective data source.

4. The computer-implemented method of claim 3 further comprising:
adjusting, by the computer, the score for each set of data collected from each respective data source in the plurality of data sources using the assigned weight to each respective score to form a weighted score for each respective data source.

5. The computer-implemented method of claim 4 further comprising:
calculating, by the computer, a total client score for each respective client device based on the weighted score for each respective data source corresponding to each respective client device.

6. The computer-implemented method of claim 5 further comprising:
sorting, by the computer, a list of client devices in descending order based on the total client score for each respective client device so that a highest-scoring client device is first in the sorted list.

7. The computer-implemented method of claim 6 further comprising:
determining, by the computer, whether space exists for allocation in the fastest data storage tier of the multi-tiered backup data storage system;
responsive to the computer determines that space does exist for allocation in the fastest data storage tier of the multi-tiered backup data storage system, pre-fetching, by the computer, backup data of the highest-scoring client device from a set of backup data storage tiers; and
loading, by the computer, the backup data of the highest-scoring client device on the fastest data storage tier of the multi-tiered backup data storage system.

8. The computer-implemented method of claim 7 further comprising:
responsive to the computer determining that space does not exist for allocation in the fastest data storage tier of the multi-tiered backup data storage system, determining, by the computer, whether backup data corresponding to lower scoring client devices exists in the fastest data storage tier; and
responsive to the computer determining that backup data corresponding to lower scoring client devices does exist in the fastest data storage tier, removing, by the computer, the backup data corresponding to the lower scoring client devices from the fastest data storage tier.

9. The computer-implemented method of claim 1, wherein the plurality of data sources is a group consisting of a backup check-in component, a missing file component, a change management component, an intelligent platform management interface component, an alerting component, and a related multi-client analysis component.

10. The computer-implemented method of claim 1, wherein the fastest data storage tier is selected from a group consisting of a solid-state drive, a flash storage, and a storage class memory.

11. The computer-implemented method of claim 10, wherein one or more other tiers of the multi-tiered backup data storage system are selected from a group consisting of a hard disk drive, a recordable compact disk, and a magnetic tape.

12. A computer system for pre-fetching and staging restore data, the computer system comprising:
a bus system;
a storage device connected to the bus system, wherein the storage device stores program instructions; and
a processor connected to the bus system, wherein the processor executes the program instructions to:
collect a set of data corresponding to a client device from each respective data source in a plurality of data sources;
determine a score for each set of data collected from each respective data source;
predict a probability of receiving a request to restore backup data on the client device based on analysis of the set of data collected from each respective data source and the score determined for each set of data collected from each respective data source;
determine whether the predicted probability of receiving a request to restore the backup data on the client device is greater than or equal to a probability threshold level; and
preemptively move the backup data of the client device to a fastest data storage tier in a multi-tiered backup data storage system in response to determining that the predicted probability of receiving a request to restore the backup data on the client device is greater than or equal to the probability threshold level.

13. The computer system of claim 12, wherein the processor further executes the program instructions to:
determine whether the request to restore the backup data on the client device was received; and
restore the backup data on the client device from the fastest data storage tier in the multi-tiered backup data storage system in response to determining that the request to restore the backup data on the client device was received.

14. The computer system of claim 12, wherein the processor further executes the program instructions to:
assign a weight to each respective score determined for each respective data source.

15. The computer system of claim 14, wherein the processor further executes the program instructions to:
adjust the score for each set of data collected from each respective data source in the plurality of data sources using the assigned weight to each respective score to form a weighted score for each respective data source.

16. A computer program product for pre-fetching and staging restore data, the computer program product comprising a computer readable storage medium having program instructions embodied therewith, the program instructions executable by a computer to cause the computer to perform a method comprising:
collecting, by the computer, a set of data corresponding to a client device from each respective data source in a plurality of data sources;
determining, by the computer, a score for each set of data collected from each respective data source;
predicting, by the computer, a probability of receiving a request to restore backup data on the client device based on analysis of the set of data collected from each respective data source and the score determined for each set of data collected from each respective data source;
determining, by the computer, whether the predicted probability of receiving a request to restore the backup data on the client device is greater than or equal to a probability threshold level; and
responsive to the computer determining that the predicted probability of receiving a request to restore the backup data on the client device is greater than or equal to the probability threshold level, preemptively moving, by the computer, the backup data of the client device to a fastest data storage tier in a multi-tiered backup data storage system.

17. The computer program product of claim 16 further comprising:
determining, by the computer, whether the request to restore the backup data on the client device was received; and
responsive to the computer determining that the request to restore the backup data on the client device was received, restoring, by the computer, the backup data on the client device from the fastest data storage tier in the multi-tiered backup data storage system.

18. The computer program product of claim 16 further comprising:
assigning, by the computer, a weight to each respective score determined for each respective data source.

19. The computer program product of claim 18 further comprising:
adjusting, by the computer, the score for each set of data collected from each respective data source in the plurality of data sources using the assigned weight to each respective score to form a weighted score for each respective data source.

20. The computer program product of claim 19 further comprising:
calculating, by the computer, a total client score for each respective client device based on the weighted score for each respective data source corresponding to each respective client device.
